(19) United States
(12) Patent Application Publication
(10) Pub. No.: US 2026/0184376 A1
(43) Pub. Date: Jul. 2, 2026

(54) VEHICLE SIDE STRUCTURE

(71) Applicant: Honda Motor Co., Ltd., Tokyo (JP)

(72) Inventor: Hiroto SUGIYAMA, Saitama (JP)

(73) Assignee: Honda Motor Co., Ltd., Tokyo (JP)

(21) Appl. No.: 19/424,171

(22) Filed: Dec. 18, 2025

(30) Foreign Application Priority Data
Dec. 31, 2024 (CN) 202411986282.7

(51) Int. Cl. B62D 25/04; G01D 11/30

(52) U.S. Cl. CPC B62D 25/04; G01D 11/30

(57) ABSTRACT

Provided is a vehicle side structure that is installed with a sensor and has good structural strength. The vehicle side structure includes: an inner plate; a grid reinforcement disposed on an outer side of the inner plate in a vehicle width direction; an outer plate disposed on an outer side of the grid reinforcement in the vehicle width direction, where the inner plate, the grid reinforcement, and the outer plate form a vehicle frame; a sensor installed in the vehicle frame, where the outer plate and the grid reinforcement are connected and form a sensor insertion hole, and the sensor is inserted into the sensor insertion hole and installed in the vehicle frame; and a strengthening component disposed between the inner plate and the sensor in the vehicle width direction and erected in a manner to span the sensor insertion hole of the grid reinforcement.

### CROSS-REFERENCE TO RELATED APPLICATION

This application claims the priority benefit of China application serial no. 202411986282.7, filed on December 31, 2024. The entirety of the above-mentioned patent application is hereby incorporated by reference herein and made a part of this specification.

### BACKGROUND

### TECHNICAL FIELD

The disclosure relates to a vehicle side structure.

### DESCRIPTION OF RELATED ART

Generally, electric vehicles are heavier than fuel vehicles, and therefore, the requirements for collision performance and structural strength of the electric vehicles are more stringent. In addition, with the popularization of an autonomous driving function, additional members such as sensors and cameras need to be installed on the vehicle body to facilitate the execution of the autonomous driving function. However, the additional members placed in conspicuous locations on the vehicle body may affect the appearance of the product.

In the existing technical documents, patent document 1 discloses a configuration structure of a peripheral information detection sensor, which may improve aerodynamic characteristics and appearance by disposing the sensor inside the pillar of the vehicle body. However, in order to dispose the sensor within the section of the pillar, the vehicle body needs to form holes in the rear of the outer plate and the side of the outer plate to place the sensor, which may reduce the strength of the pillar of the vehicle body, thereby affecting the collision performance of the automobile and the structural strength of the vehicle body.

### Prior Art Documents

### Patent Documents

Patent Document 1: Japanese Patent Publication No. 6547665

### SUMMARY

The disclosure provides a vehicle side structure that is installed with a sensor and has good structural strength.

The disclosure provides a vehicle side structure. The vehicle side structure includes: an inner plate; a grid reinforcement disposed on an outer side of the inner plate in a vehicle width direction; an outer plate disposed on an outer side of the grid reinforcement in the vehicle width direction, where the inner plate, the grid reinforcement, and the outer plate form a vehicle frame; a sensor installed in the vehicle frame, where the outer plate and the grid reinforcement are connected together and form a sensor insertion hole, and the sensor is inserted into the sensor insertion hole and installed in the vehicle frame; and a strengthening component disposed between the inner plate and the sensor in the vehicle width direction and erected in a manner to span the sensor insertion hole of the grid reinforcement.

In an embodiment of the disclosure, the inner plate, the grid reinforcement, and the strengthening component form a closed section.

In an embodiment of the disclosure, in the closed section, the strengthening component forms a protrusion protruding toward a side of the outer plate.

In an embodiment of the disclosure, in the closed section, the strengthening component forms at least two protrusions, and a recess recessed toward a side of the inner plate is formed between the protrusions, and the sensor is configured to face the recess.

In an embodiment of the disclosure, the grid reinforcement forms a cap-shaped section open toward a side of the inner plate, the sensor insertion hole is formed in a cap body of the cap-shaped section of the grid reinforcement, the strengthening component forms a cap-shaped section open toward a side of the outer plate, and a cap body of the cap-shaped section of the strengthening component faces the sensor in the vehicle width direction.

In an embodiment of the disclosure, the grid reinforcement has a connection surface, the connection surface is connected to a joint surface between the grid reinforcement and the inner plate and the cap body of the cap-shaped section of the grid reinforcement, and the strengthening component is connected to the connection surface of the grid reinforcement.

In an embodiment of the disclosure, multiple sensors are provided along an extending direction of the vehicle frame, and the strengthening component is formed in a manner to cover a range where the sensors are provided.

Based on the above, the vehicle side structure is disposed by the strengthening component being erected in a manner to span across the sensor insertion hole formed in the grid reinforcement, and even if the sensor insertion hole is formed in the outer plate and the grid reinforcement, reduction of the overall structural strength may be suppressed. Moreover, by having the inner plate, the grid reinforcement and the strengthening component form a closed section, the structural strength may be further ensured. Furthermore, the depth of the closed section may also be formed through a sectional design where the grid reinforcement and the strengthening component cooperate with each other, to further ensure a space configured to dispose the sensor. Additionally, by having the strengthening component connected to the surroundings of the joint surface between the grid reinforcement and the inner plate, load may also be more easily transmitted to the inner plate, thereby enabling formation of a more robust closed section.

To make the above features and advantages of the disclosure more comprehensible, embodiments are specifically provided below and described in detail in conjunction with the accompanying drawings as follows.

### BRIEF DESCRIPTION OF THE DRAWINGS

FIG. 1 is a schematic view of a vehicle side structure according to an embodiment of the disclosure.

FIG. 2A is a schematic side view of the vehicle side structure in FIG. 1 after a sensor is removed.

FIG. 2B is a schematic side view of the vehicle side structure in FIG. 2A after an outer plate removed.

FIG. 2C is a schematic side view of a strengthening component in FIG. 2B.

FIG. 2D is a schematic side view of a sensor in FIG. 1.

FIG. 3 is a schematic cross-sectional view of the vehicle side structure in FIG. 1 along line A-A.

### DESCRIPTION OF THE EMBODIMENTS

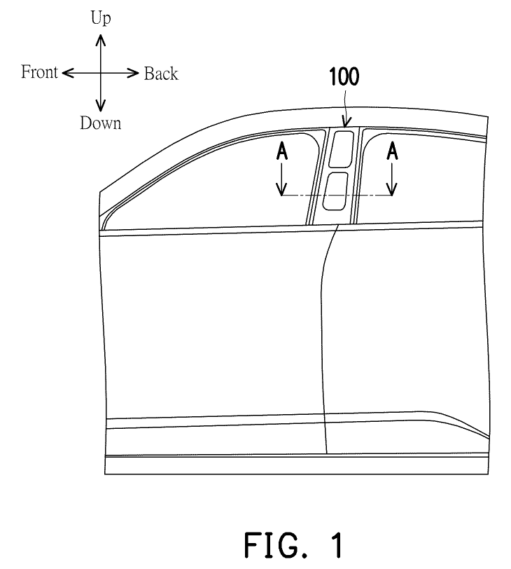

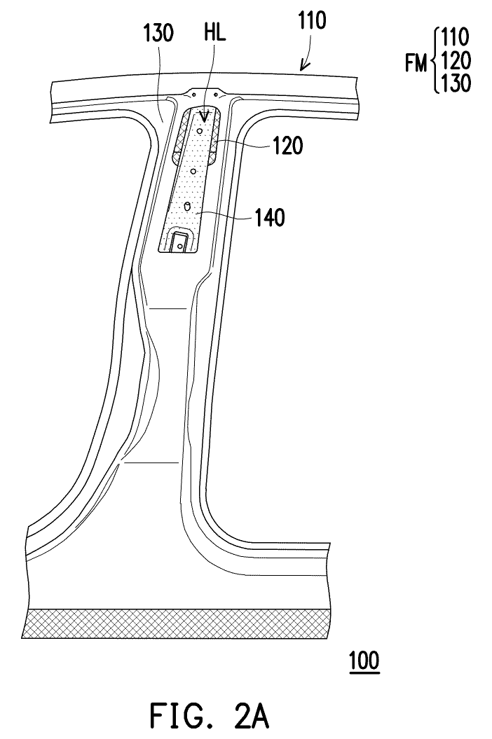

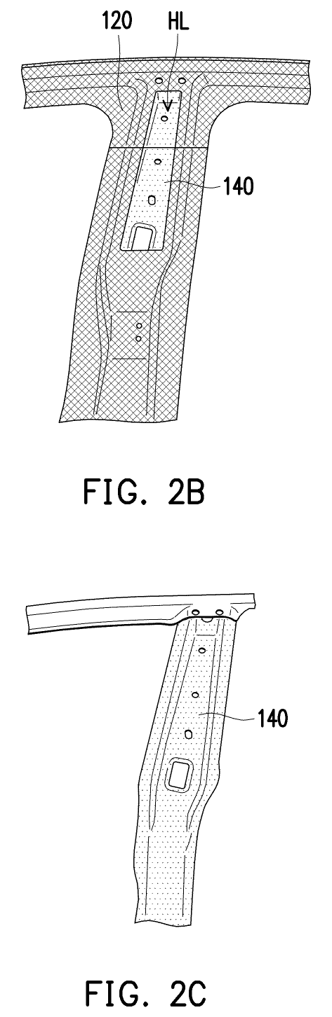

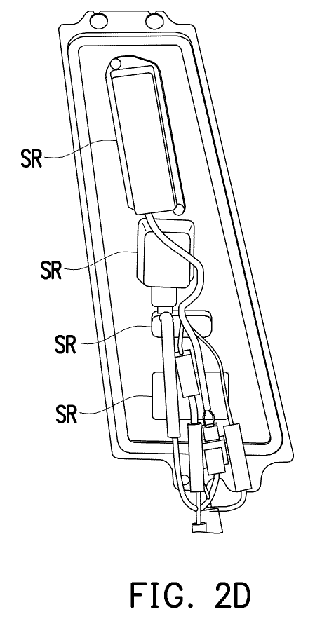

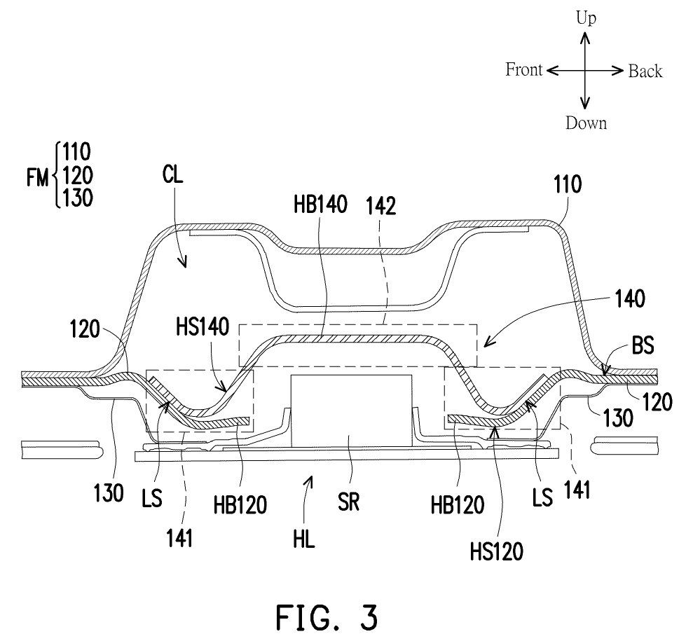

FIG. 1 is a schematic view of a vehicle side structure according to an embodiment of the disclosure. FIG. 2A is a schematic side view of the vehicle side structure in FIG. 1 after a sensor is removed. FIG. 2B is a schematic side view of the vehicle side structure in FIG. 2A after an outer plate removed. FIG. 2C is a schematic side view of a strengthening component in FIG. 2B. FIG. 2D is a schematic side view of a sensor in FIG. 1. FIG. 3 is a schematic cross-sectional view of the vehicle side structure in FIG. 1 along line A-A. It should be noted that, for convenience, a front-back direction, a left-right direction, and an up-down direction of the vehicle are defined as shown in the figures, and the configuration of each part is described according to this definition. The front-back direction, the left-right direction, and the up-down direction correspond to a vehicle length direction, a vehicle width direction, and a vehicle height direction of the vehicle, respectively. The specific structure of the vehicle side structure 100 is described below with references to FIG. 1 to FIG. 3.

Please refer to FIG. 1 to FIG. 3. In this embodiment, the vehicle side structure 100 includes an inner plate 110, a grid reinforcement 120, an outer plate 130, a sensor SR, and a strengthening component 140. As shown in FIG. 2A to FIG. 3, in this embodiment, the inner plate 110, the grid reinforcement 120, and the outer plate 130 form a vehicle frame FM. The outer plate 130 and the grid reinforcement 120 are connected together and form a sensor insertion hole HL. The sensor SR is inserted into the sensor insertion hole HL and installed in the vehicle frame FM to form the vehicle side structure 100 as shown in FIG. 1. For example, in this embodiment, multiple sensors SR are provided along an extending direction of the vehicle frame FM, and the strengthening component 140 is formed in a manner to cover a range where the sensors SR are provided. Furthermore, as shown in FIG. 3, in the vehicle width direction of this embodiment, the grid reinforcement 120 is disposed on an outer side of the inner plate 110, the outer plate 130 is disposed on an outer side of the grid reinforcement 120, the strengthening component 140 is disposed between the inner plate 110 and the sensor SR, and the strengthening component 140 is erected in a manner to span the sensor insertion hole HL of the grid reinforcement 120.

In this way, the strengthening component 140 is erected in a manner to span the sensor insertion hole HL formed in the grid reinforcement 120, and even if the sensor insertion hole HL is formed on the outer plate 130 and the grid reinforcement 120, so the reduction of overall structural strength may be suppressed by disposing the strengthening component 140. Moreover, since the strengthening component 140 is formed in a manner to cover the range where the sensors SR are provided, the overall structural strength may be further ensured.

In another aspect, as shown in FIG. 3, in this embodiment, the inner plate 110, the grid reinforcement 120, and the strengthening component 140 may form a closed section CL. Through the formation of the closed section CL, structural strength may be further ensured, and even if the sensor SR is disposed within the vehicle frame FM, the structural strength of the vehicle frame FM may be ensured.

Furthermore, as shown in FIG. 3, in the closed section CL of this embodiment, the strengthening component 140 further forms a protrusion 141 that protrudes toward a side of the outer plate 130. Thus, by disposing the protrusion 141 where the strengthening component 140 protrudes toward the side of the outer plate 130, the rigidity of the overall structure may be further improved. In another aspect, in the closed section CL, the strengthening component 140 may further form at least two protrusions 141, a recess 142 that recesses toward a side of the inner plate 110 is formed between the protrusions 141, and the sensor SR is configured to face the recess 142. Therefore, while the rigidity is ensured, sufficient space existing within the closed section CL configured to dispose the sensor SR may also be ensured.

Furthermore, in this embodiment, a depth of the closed section CL may also be formed through the cross-sectional design where the grid reinforcement 120 and the strengthening component 140 cooperate with each other, to further improve the overall structural strength and ensure the space configured to dispose the sensor SR. For example, as shown in FIG. 3, in the closed section CL of this embodiment, the grid reinforcement 120 forms a cap-shaped section HS120 open toward the side of the inner plate 110, and the sensor insertion hole HL is formed in the cap body HB120 of the cap-shaped section HS120 of the grid reinforcement 120, while the strengthening component 140 forms a cap-shaped section HS140 open toward the side of the outer plate 130, and the cap body HB140 of the cap-shaped section HS140 of the strengthening component 140 faces the sensor SR in the vehicle width direction. Therefore, as shown in FIG. 3, since the cross-section of the grid reinforcement 120 in the closed section CL is formed as the cap-shaped section HS120 open toward the side of the inner plate 110, the depth of the closed section CL formed by the grid reinforcement 120 connected to the inner plate 110 may be formed with a deeper dimension, thereby improving the overall structural strength. In another aspect, since the cross-section of the strengthening component 140 in the closed section CL is also formed as the cap-shaped section HS140 open toward the side of the outer plate 130, and the cap body HB140 of the cap-shaped section HS140 of the strengthening component 140 faces the sensor SR in the vehicle width direction, the depth dimension of the installation space for the sensor SR may be further deepened, thereby ensuring the installation space for the sensor SR.

Furthermore, as shown in FIG. 3 of this embodiment, the grid reinforcement 120 has a connection surface LS configured to connect the joint surface BS between the grid reinforcement 120 and the inner plate 110 and the cap body HB120 of the cap-shaped section HS120 of the grid reinforcement 120, and the strengthening component 140 is connected to the connection surface LS of the grid reinforcement 120. Therefore, since the strengthening component 140 is connected to the surroundings of the joint surface BS between the grid reinforcement 120 and the inner plate 110, load may be more easily transmitted to the inner plate 110, thereby enabling formation of a more robust closed section CL.

To sum up, in the embodiments of the disclosure, the vehicle side structure is disposed by the strengthening component being erected in a manner to span across the sensor insertion hole formed in the grid reinforcement, and even if the sensor insertion hole is formed in the outer plate and the grid reinforcement, reduction of the overall structural strength may be suppressed. Moreover, by having the inner plate, the grid reinforcement, and the strengthening component form a closed section, the structural strength may be further ensured. Furthermore, the depth of the closed section may also be formed through the cross-sectional design where the grid reinforcement and the strengthening component cooperate with each other, to further ensure the space configured to dispose the sensor. Additionally, by having the strengthening component connected to the surroundings of the joint surface between the grid reinforcement and the inner plate, load may also be more easily transmitted to the inner plate, thereby enabling the formation of a more robust closed section.

Finally, it should be noted that: the aforementioned embodiments are only used to describe the technical solutions of the disclosure, rather than to limit thereto. Although the disclosure has been described in detail with reference to the aforementioned embodiments, persons skilled in the art should understand that: the technical solutions described in the aforementioned embodiments may still be modified, or equivalent substitutions for some or all of the technical features therein may be made. These modifications or substitutions do not cause the essence of the corresponding technical solutions to depart from the scope of the technical solutions of the embodiments of the disclosure.

What is claimed is:

1. A vehicle side structure, comprising:
an inner plate;
a grid reinforcement, disposed on an outer side of the inner plate in a vehicle width direction;
an outer plate, disposed on an outer side of the grid reinforcement in the vehicle width direction, wherein the inner plate, the grid reinforcement, and the outer plate form a vehicle frame;
a sensor, installed in the vehicle frame, wherein the outer plate and the grid reinforcement are connected together and form a sensor insertion hole, and the sensor is inserted into the sensor insertion hole and installed in the vehicle frame; and
a strengthening component, disposed between the inner plate and the sensor in the vehicle width direction and erected in a manner to span the sensor insertion hole of the grid reinforcement.

2. The vehicle side structure according to claim 1, wherein the inner plate, the grid reinforcement, and the strengthening component form a closed section.

3. The vehicle side structure according to claim 2, wherein in the closed section, the strengthening component forms a protrusion protruding toward a side of the outer plate.

4. The vehicle side structure according to claim 3, wherein in the closed section, the strengthening component forms at least two protrusions, and a recess recessed toward a side of the inner plate is formed between the protrusions, and the sensor is configured to face the recess.

5. The vehicle side structure according to claim 1, wherein the grid reinforcement forms a cap-shaped section open toward a side of the inner plate;
the sensor insertion hole is formed in a cap body of the cap-shaped section of the grid reinforcement; and
the strengthening component forms a cap-shaped section open toward a side of the outer plate, and a cap body of the cap-shaped section of the strengthening component faces the sensor in a vehicle width direction.

6. The vehicle side structure according to claim 5, wherein the grid reinforcement has a connection surface, the connection surface is connected to a joint surface of the grid reinforcement and the inner plate and the cap body of the cap-shaped section of the grid reinforcement, and the strengthening component is connected to the connection surface of the grid reinforcement.

7. The vehicle side structure according to claim 1, wherein a plurality of sensors are provided along an extending direction of the vehicle frame, and the strengthening component is formed in a manner to cover a range where the plurality of sensors are provided.
